(19) United States
(12) Patent Application Publication
(10) Pub. No.: US 2021/0236933 A1
(43) Pub. Date: Aug. 5, 2021

(54) Deque System of Representational Game State

(71) Applicant: Ryan Michael Gibbons, Littleton, CO (US)

(72) Inventor: Ryan Michael Gibbons, Littleton, CO (US)

(21) Appl. No.: 16/779,627

(22) Filed: Feb. 2, 2020

(51) Int. Cl. A63F 13/58; A63F 13/57; G06F 9/48

(52) U.S. Cl. CPC A63F 13/58; G06F 9/4881; A63F 13/57

(57) ABSTRACT

A system that allows direct manipulation of numerical parameters while playing games. Vertical columns of physical units are formed into deques that each represent between one and three parameters of the game state at a given time. The game's mechanics are defined as a set of state transitions, each of which map a configuration of units/deques, along with a nonnegative integer input, to a new configuration of units/deques. This new configuration directly represents the resultant game state and parameters thereof, and is naturally subject to further systematic manipulation.

### CROSS-REFERENCE TO RELATED APPLICATIONS

Not Applicable

### STATEMENT REGARDING FEDERALLY SPONSORED RESEARCH OR DEVELOPMENT

Not Applicable

### REFERENCE TO LISTING ON COMPACT DISC

Not Applicable

### BACKGROUND OF THE INVENTION

### Field of Use

Managing the evolution of state in games.

### Background

Games that involve sophisticated state and mechanics, such as tabletop role-playing games, define and utilize many numerical parameters, along with even more rules that govern their evolution. This presents a problem: the resulting complexity must be carefully managed, lest the state configurations and calculations grow intractable for the players. It is the primary purpose of the present invention to encapsulate game state, and its transitions into new states—invoked by player choices, feedback loops, random elements, etc.—in a framework that directly represents the underlying game components, and can be directly manipulated by the players.

### BRIEF SUMMARY OF THE INVENTION

<Summary as Claimed> A system that encapsulates game state and mechanics comprising:
(a) vertical columns of physical units that function as double-ended queues (“deques”),
(b) a set of designations for subsets of the units,
(c) a set of deque definitions, and
(d) a set of state transition functions that transfer units between deques,
   whereby players of games are afforded a means to directly manipulate and account for the numerical parameters relevant to them.

<Notes on (a)> The vertical columns of units are the physical component of the present invention. The methods by which they are formed, and manipulated, and by which meaning is prescribed to them, are its remaining components.

<Notes on (b)> The total set of units is partitioned into mutually exclusive subsets, thereby distinguishing finite numbers of units from the others. This is accomplished by first identifying the numerical parameters of the game state being represented. Then, each parameter is mapped to a unique designation of units. The number of units of each designation is given by the numerical constraints on the parameter it represents. Generally, these constraints must correspond to a finite range over the nonnegative integers. Parameters that do not initially conform to this standard must be normalized.

<Notes on (c)> Each deque is defined as an ordered list of between one and three unit designations. The position of each unit designation in these defining lists specifies how the units of said designation will be added to the referencing deck—via either stacking, auto-stacking, or queuing.

<Notes on (d)> The state transition functions each implicitly map a given configuration of game state to another (possibly identical) configuration of game state. Explicitly, they each map a given nonnegative integer to another (possibly identical) nonnegative integer. Together, they encode the game mechanics that are responsible for evolving a game state.

### BRIEF DESCRIPTION OF THE SEVERAL VIEWS OF THE DRAWING

FIG. 1—Introduces the physical components of the invention. q is a pool queuing units; a is a pool of auto-stacking units; s is a pool of stacking units; D is a deque of s, a, and q units.

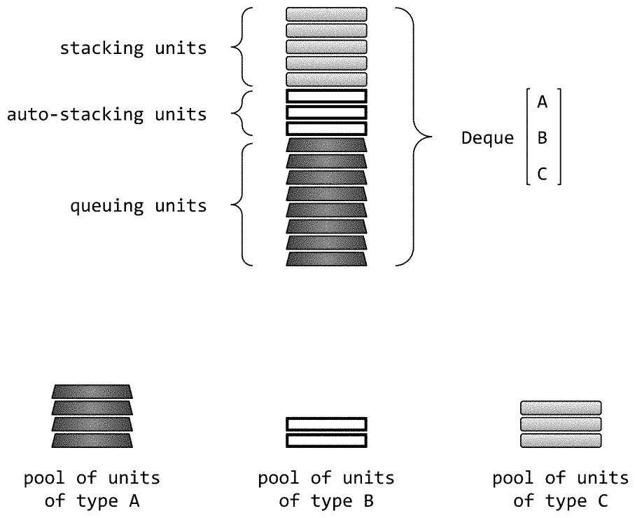

FIG. 2—Shows the Example in some initial configuration. q is the pool of queuing “health” units; a is the pool of auto-stacking “armor” units; s is the pool of stacking “mana” units; u is the pool of queuing “energy” units; H is the “Health” deque; E is the “Energy” deque.

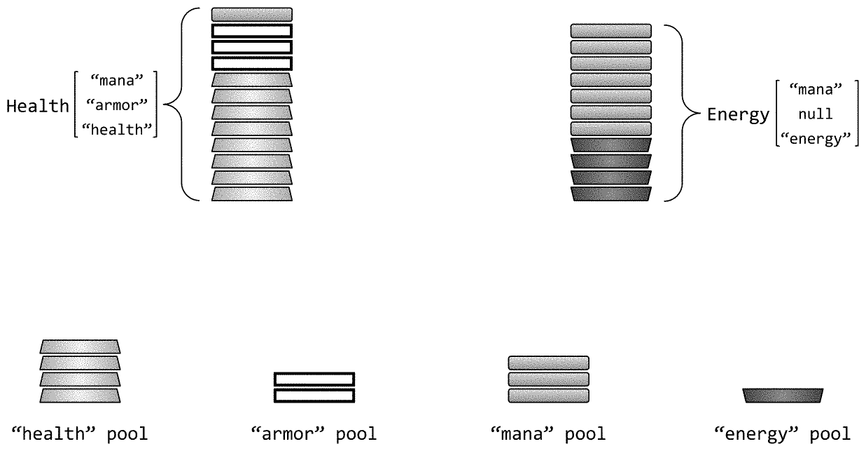

FIG. 3—Shows the take-damage( ) transition of the Example. n is the number of units popped from the “Health” deque.

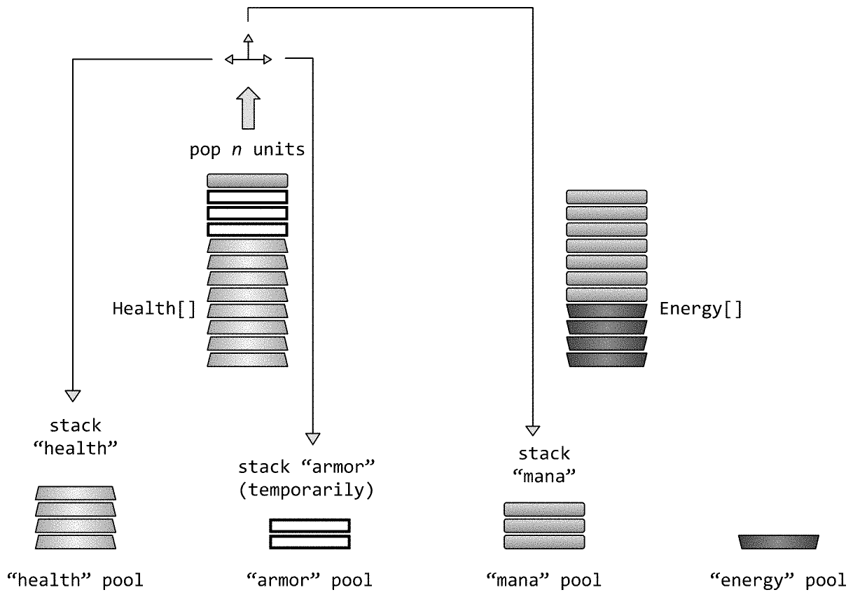

FIG. 4—Shows the heal-damage( ) transition of the Example. n is the number of units popped from the “health” pool.

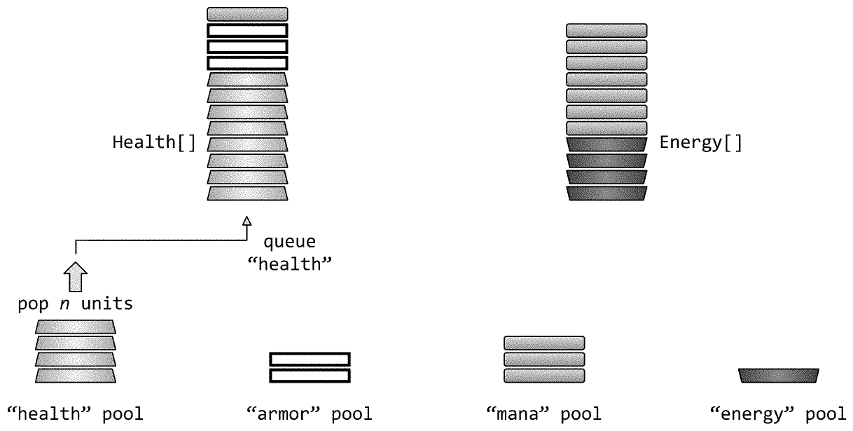

FIG. 5—Shows the consume-mana( ) and consume-energy( ) transitions of the Example. n is the number of units popped from the “Energy” deque.

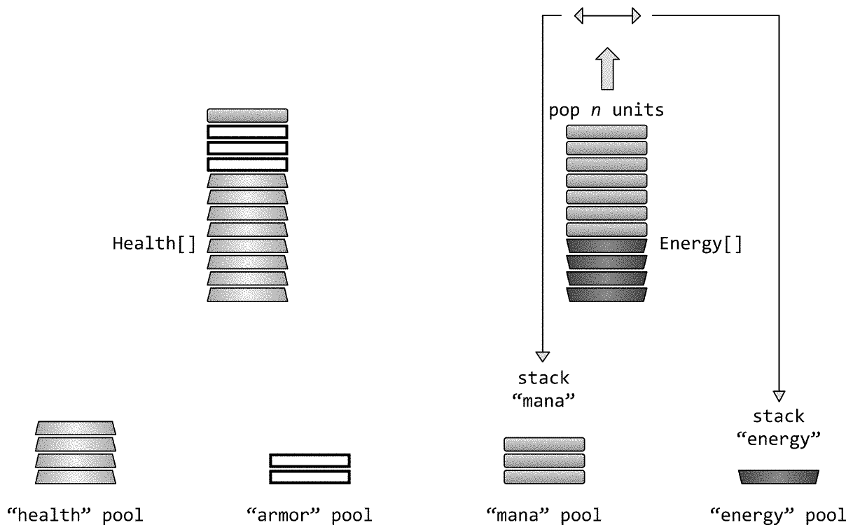

FIG. 6—Shows the restore-mana( ) transition of the Example. n is the number of units popped from the “mana” pool.

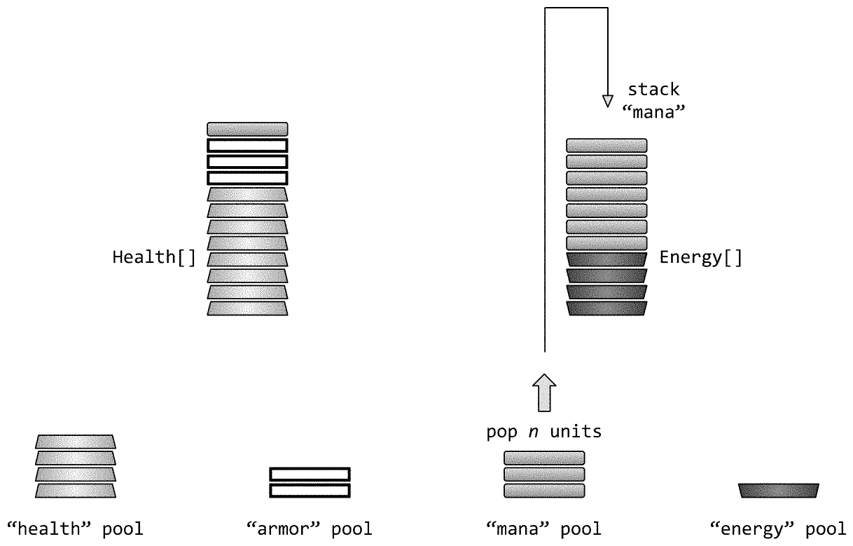

FIG. 7—Shows the use-mana-shield( ) transition of the Example. n is the number of units popped from the “Energy” deque.

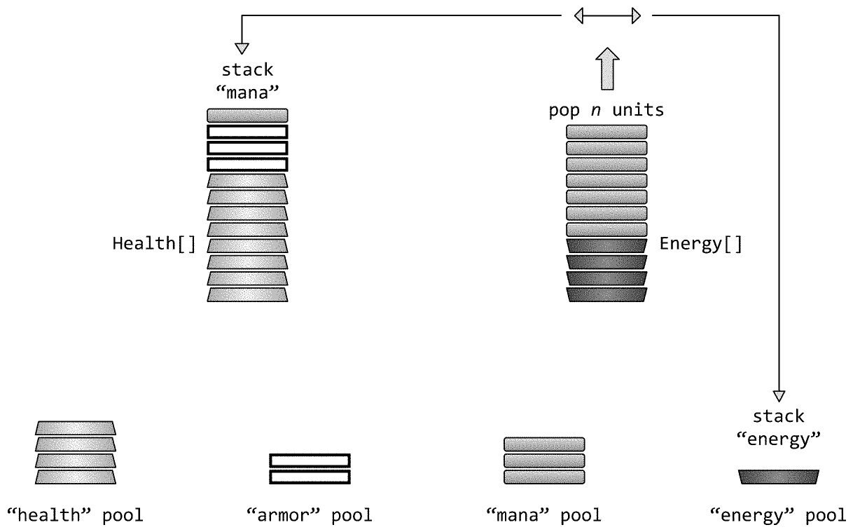

FIG. 8—Shows the use-blood-tap( ) transition of the Example. n is the number of units popped from the “Health” deque. k is the number of units then popped from the “mana” pool.

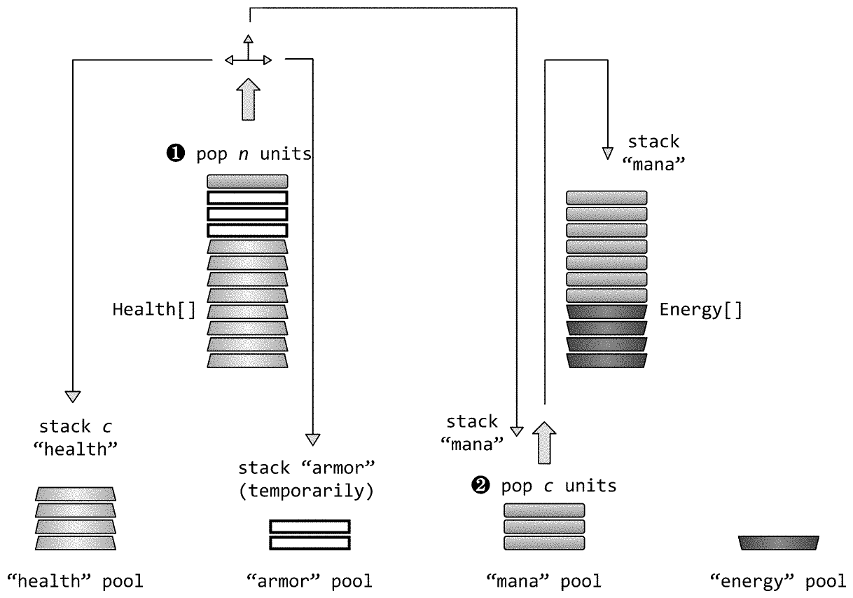

FIG. 9—Shows the use-rejuvenation( ) transition of the Example. n is the number of units popped from the “Energy” deque. k is the number of units then popped from the “health” pool. j is the number of units then popped from the “health” pool again.

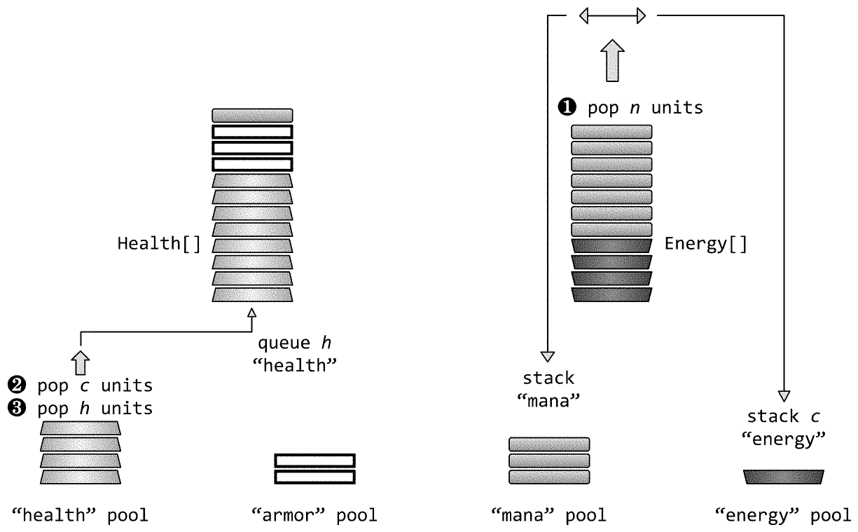

### DETAILED DESCRIPTION OF THE INVENTION

### Overview

The present invention, here referred to as the “Deque System,” consists of three ingredients: Units, Deques, and state Transitions. Each ingredient has a well-defined schema, and is instantiated with respect to a given game. Here, the schema for each component of the Deque System will be defined, followed by a simple example. Then, a complex example (the Example) will be given by constructing an instance of the Deque System for a state typical of role-playing games. First of all, the main terminology used throughout this section is introduced below.

<Terminology: unit> A “unit” is any discrete, stackable, and distinguishable physical object. Here, distinguishable means that individual units can be colored, marked, or otherwise made to be clearly partitioned into mutually exclusive subsets of all units in use.

<Terminology: unit type> A “unit type” is a unique designation assigned to an exclusive subset of all units in use.

<Terminology: deque> A “deque” is a double-ended queue. Here, it specifically refers to a vertical column of units, which may be extended by placing new units either on top of it, or underneath it, and which may be reduced only by removing units from its top.

<Terminology: pop> The verb “pop” means here the act of removing a unit from the top of a deque. Units always pop; they are never removed from the bottom of a deque.

<Terminology: stack> The verb “stack” means here the act of adding to a deque from the top. A deque's stacking unit type always stacks onto it.

<Terminology: auto-stack> The verb “auto-stack” means here the act of stacking all units back onto a deque at the end of any transition in which they were popped. A deque's auto-stacking unit type (if it has one) always auto-stacks onto it.

<Terminology: queue> The verb “queue” means here the act of adding to a deque from the bottom. A deque's queuing unit type (if it has one) always queues into it.

<Terminology: game state/mechanics> The Deque System primarily models the dynamic parameters of a game that players track as it is played. The specific configuration of all such parameters at a given time is a “game state.” The rules by which the game state is allowed to evolve in time are the “mechanics” of the game.

<Terminology: state transition> A “state transition” is a function that maps a given nonnegative integer, implicitly along with a game state, to another nonnegative integer, implicitly along with a new game state. State transitions operate on arbitrary state, and reference only the unit types and deque definitions known a priori. Thus, a game may start in any initial configuration of Units and Deques, and evolve through a series of state transitions, which are always well-defined, with the following proviso: transitions immediately resolve when they require a unit to pop from a deque that is empty.

<Schema: Units> Exactly one unit type is defined per numerical parameter of the game state. The number of units of a given type is set by the numerical constraints on the parameter that the unit type represents. These constraints must correspond to a finite range over the nonnegative integers. The set of all unit types is the first ingredient of the Deque System. For example:
Units:={“health”, “mana”}

<Schema: Deques> A deque is defined by a 3-tuple of unit types. The first element of the tuple specifies which unit type stacks onto the deque being defined; the second element specifies which unit type auto-stacks onto it; and the third element specifies which unit type queues into it. The first (stacking) element must refer to a unit type. The second (auto-stacking) and third (queuing) elements may optionally refer to null, to indicate that there is no such unit type for the deque being defined. The set of all deques is the second ingredient of the Deque System. For example:
Deques:={Health[ ], Mana[ ]}
   Health[ ]:=(“health”, null, null)
   Mana[ ]:=(“mana”, null, null)

<Corollary: pool> Given the definitions for Units and Deques, it follows that each unit type “C” implicitly defines a deque: C[ ]:=(“C”, null, null). This implicit deque represents the finite source, or “pool,” of “C” units. It is assumed that exactly one such pool exists per unit type. In the state transition definitions that follow, any given pool will be written as the unnamed deque “[ ]”, where the specific pool it represents can be inferred by the type of unit interacting with it. The notation “@[ ]” will be used for the pool of a unit that is temporarily stacking onto it, before auto-stacking back onto the deque whence it popped.

<Schema: Transitions> State transitions are defined as either: (a) exactly one statement of the form “count <unit type> while pop <nonnegative integer> from <deque> where <stacking unit type>→<deque>, <auto-stacking unit type>→<deque>, <queuing unit type>→<deque>”; or (b) the composition of two (or more) state transitions. The auto-stacking and queuing clauses may be omitted when their respective unit types are null. The count clause determines which unit type to tally as it pops, and the function shall evaluate to the total tally to resolve the transition. The set of all state transitions is the third and final ingredient of the Deque System. For example:
Transitions:={take-damage( ), consume-mana( )}
   take-damage(n):=count “health” while pop n from Health[ ] where “health”→[ ]
   consume-mana(n):=count “mana” while pop n from Mana[ ] where “mana”→[ ]

### EXAMPLE

Consider a game whose players are concerned with following numerical parameters: health, mana, energy, and armor. Additionally, the game mechanics stipulate that: health is decremented by damaging effects (Sheet 3); health is incremented by healing effects (Sheet 4); armor protects health from damage and is never depleted (Sheet 3); mana/energy is decremented by effects that consume them (Sheet 5); mana is incremented by effects that restore it (Sheet 6); mana-shield: mana may be decremented to protect health, but is then decremented by damage (Sheet 7, Sheet 3); blood-tap: damage may be taken so that any lost health is converted 1:1 into mana (Sheet 8); rejuvenation: mana/energy may be consumed so that any lost energy is converted 1:2 into health (Sheet 9). The basic objective of this game might be to prevent health and energy from decrementing to zero. Now, the following instantiation of the Deque System captures all stated parameters and mechanics, and allows them to be tracked and directly manipulated by the players.
Units:={“health”, “mana”, “energy”, “armor”}
Deques:={Health[ ], Energy[ ]}
   Health[ ]:=(“mana”, “armor”, “health”)
   Energy[ ]:=(“mana”, null, “energy”)
Transitions:={take-damage( ), heal-damage( ), consume-mana( ), restore-mana( ), use-mana-shield( ), use-blood-tap( ), use-rejuvenation( )}
   take-damage(n):=count “health” while pop n from Health[ ] where “mana”→[ ], “armor”→@[ ], “health”→[ ]
   heal-damage(n):=count “health” while pop n from [ ] where “health”→Health[ ]
   consume-mana(n):=count “mana” while pop n from Energy[ ] where “mana”→[ ], “energy”→[ ]
   restore-mana(n):=count “mana” while pop n from [ ] where “mana”→Energy[ ]
   consume-energy(n):=count “energy” while pop n from Energy[ ] where “mana”→[ ], “energy”→[ ]
   use-mana-shield(n):=count “mana” while pop n from Energy[ ] where “mana”→Health[ ], “energy”→[ ]
   use-blood-tap(n):=restore-mana(take-damage(n))
   use-rejuvenation(n):=
   heal-damage(heal-damage(consume-energy(n)))

1. A system that encapsulates game state and mechanics comprising:
(a) vertical columns of physical units that function as double-ended queues (“deques”),
(b) a set of designations for subsets of the units,
(c) a set of deque definitions, and
(d) a set of state transition functions that transfer units between deques,
whereby players of games are afforded a means to directly manipulate and account for the numerical parameters relevant to them.
